(19) United States
(12) Patent Application Publication
(10) Pub. No.: US 2014/0243095 A1
(43) Pub. Date: Aug. 28, 2014

(54) SERVER DEVICE

(71) Applicant: DeNA Co., Ltd., Tokyo (JP)

(72) Inventors: Ryuji IKEDA, Tokyo (JP); Kenichi IWAO, Tokyo (JP)

(73) Assignee: DeNA Co., Ltd., Tokyo (JP)

(21) Appl. No.: 14/031,639

(22) Filed: Sep. 19, 2013

(30) Foreign Application Priority Data
Feb. 27, 2013 (JP) 2013-037191

(51) Int. Cl. A63F 13/30

(52) U.S. Cl. CPC A63F 13/12
USPC 463/42

(57) ABSTRACT

There is provided a new function of effectively using game media without making a player feel monotonous in a battle game using game media. A server device is connected to an information processing terminal through a network, and controls a game in which a player battles with another player by operating game media in game space. The server device includes a storage unit that stores player information including information on the plurality of game media possessed by the player and a game item possessed by the player; a conversion unit that converts a predetermined game content from among the plurality of game media possessed by the player into a game item different than the game content; and an information changing unit that changes the player information such that the converted game content is managed as a game item.

### BACKGROUND OF THE INVENTION

1. Field of the Invention

The present invention relates to a server device.

2. Description of the Related Art

There is known a server device that controls a battle game in which while a player collects game cards such as character cards, the player battles with another player using the game cards (for example, JP 2008-264183 A).

### SUMMARY OF THE INVENTION

In such a game, when the number of game cards possessed by the player increases, it is common to use the function of reinforcing game cards by combining the cards together or evolving the cards. In addition, by using such a combining function, the player can dispose of unnecessary cards among his/her game cards and thus can effectively use the unnecessary game cards. However, combining which is performed as an effective use of game cards is a factor in making the player feel monotonous for the game.

The present invention is made in view of such circumstances, and an object of the present invention is to provide a new function of effectively using game media without making a player feel monotonous in a battle game using game media.

The main aspect of the present invention to solve the above-described problem is directed to a server device connected to an information processing terminal through a network and controlling a game in which a player battles with another player by operating game media in game space, the server device including: a storage unit that stores player information including information on the plurality of game media possessed by the player and a game item possessed by the player; a conversion unit that converts a predetermined game content from among the plurality of game media possessed by the player into a game item different than the game content; and an information changing unit that changes the player information such that the converted game content is managed as a game item.

Other characteristics of the present invention will become clear from the description of the present specification and the appended drawings.

According to the present invention, a new function of effectively using game media without making a player feel monotonous in a battle game using game media can be provided.

### BRIEF DESCRIPTION OF THE DRAWINGS

FIG. 1 is a diagram illustrating an example of an overall configuration of a game system according to the present embodiment;

FIG. 2 is a block diagram illustrating a functional configuration of a server device according to the present embodiment;

FIG. 3 is a block diagram illustrating a functional configuration of a player terminal according to the present embodiment;

FIG. 4 is a diagram illustrating an example of a battle screen of the game system according to the present embodiment;

FIG. 5 is a diagram illustrating an example of a data structure of game card information;

FIG. 6 is a diagram illustrating an example of a data structure of game item information;

FIG. 7 is a diagram illustrating an example of a data structure of game cards possessed by players among player information;

FIG. 8 is a diagram illustrating an example of a data structure of items possessed by the players among the player information;

FIG. 9 is a diagram describing operation performed upon gaining an undead creation item;

FIG. 10 is a diagram describing the flow of battle operation of the game system; and

FIG. 11 is a diagram describing operation in battle processing which is performed when an undead character is allowed to participate in a battle.

### DETAILED DESCRIPTION OF THE INVENTION

At least the following matters will become clear according to the description of the present specification and the appended drawings.

There is provided a server device connected to an information processing terminal through a network and controlling a game in which a player battles with another player by operating game media in game space, the server device including: a storage unit that stores player information including information on the plurality of game media possessed by the player and a game item possessed by the player; a conversion unit that converts a predetermined game content from among the plurality of game media possessed by the player into a game item different than the game content; and an information changing unit that changes the player information such that the converted game content is managed as a game item.

According to such a server device, a new function of effectively using game media without making the player feel monotonous can be provided.

In addition, the server device may further include a battle processing unit that exercises, when there is a request from the player to consume the game item upon doing the battle, predetermined functions of the game item in response to the request.

According to such a server device, according to a game item possessed by the player, the functions of the item can be exercised during the battle.

In addition, in the server device, the predetermined functions of the game item may include: creating a participation game content that participates in the battle; consuming a parameter set for the participation game content when the participation game content participates in the battle; and not allowing the consumed parameter to recover during the battle.

According to such a server device, by the player creating a participation game content which functions like a disposable piece in the battle and allowing the participation game content to participate in the battle, the player can allow the battle to progress advantageously.

In addition, the storage unit may store information about a number of the game items, as the player information, and the information changing unit may change the player information such that every time the conversion is performed, the converted game content from among the game media possessed by the player is removed, and an addition is performed on the number of the game items possessed by the player.

According to such a server device, a participation game content can be created by converting a predetermined game card possessed by the player into a game item and managing the quantity of the game items.

In addition, in the server device, the game content being a conversion source may be set with a parameter same as or different than a parameter set for the participation game content created using the game item being a conversion destination.

According to such a server device, a participation game content having a parameter weaker than a parameter set for a conversion source game content (game card) can be created. By this, even if the participation game content is allowed to participate in the battle, loss of balance in the battle is less likely to occur.

In addition, in the server device, when the battle processing unit creates the participation game content from the game item, the battle processing unit may set a parameter of the participation game content, based on a parameter set for a specific game content among the plurality of game media possessed by the player.

According to such a server device, a participation game content having a predetermined parameter, with a parameter set for a specific game content (game card) which is a conversion source being a reference parameter can be created. By this, the importance of the specific game content can be further increased.

In addition, in the server device, the parameter may include information on at least any one of attack point, defense point, hit point, and level of the game content or the participation game content.

According to such a server device, the participation game content is set with a predetermined strength.

In addition, in the server device, the participation game content may have predetermined rarity, and a parameter set for the participation game content may vary according to the rarity.

According to such a server device, since the strength of the participation game content can be made vary according to the level of rarity, a difference can be made in importance as a force between participation game media.

In addition, in the server device, the participation game content may have predetermined rarity, and the participation game content may be set with a skill according to the rarity.

According to such a server device, since the participation game content can be allowed to have a special ability having an effect that varies according to the level of rarity, a difference can be made in importance as a force between participation game media.

### Embodiment

### Configuration of Game System 1

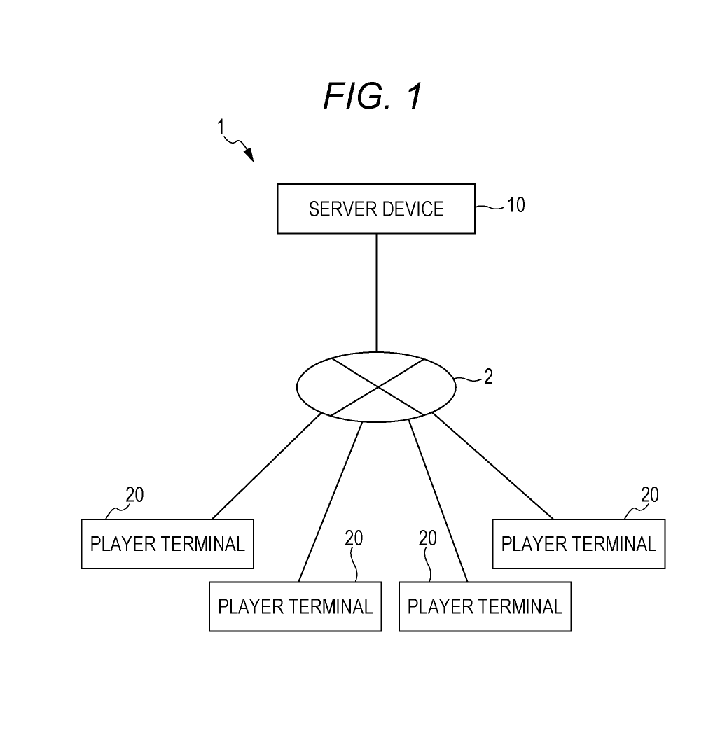

FIG. 1 is a diagram illustrating an example of an overall configuration of a game system 1 according to the present embodiment.

The game system 1 provides a user (hereinafter, also called a “player”) with various types of services related to a game (a social game and the like) through a network 2. The game system 1 includes a server device 10 and a plurality of player terminals 20 which are connected to the network 2 in a communicable manner.

The player can play a game transmitted through the network 2, by accessing the game system 1 from the player terminal 20. In addition, the player can communicate with a plurality of other players by accessing the game system 1.

The game system 1 of the present embodiment provides a game in which the player can do battle with another player.

### <Server Device 10>

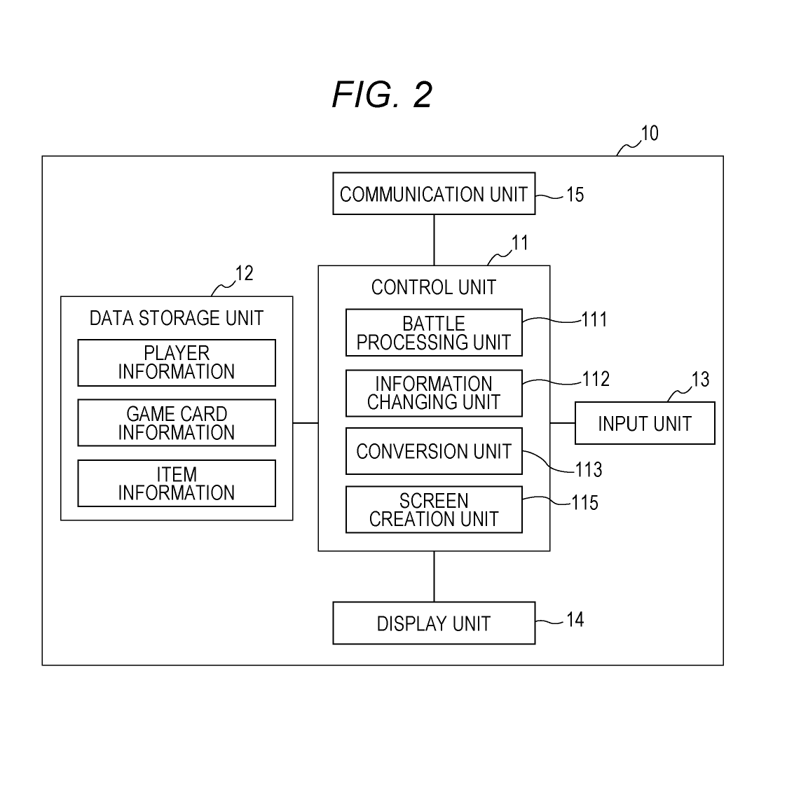

FIG. 2 is a block diagram illustrating a functional configuration of a server device. The server device 10 is an information processing device (for example, a workstation, a personal computer, and the like) used when a system administrator and the like manage the game service. The server device 10 can distribute a game program operable on the player terminal 20, and a web page made in a markup language (HTML, and the like) according to a specification of the player terminal 20 upon receiving various commands (requests) from the player terminal 20. The server device 10 of the present embodiment includes a control unit 11, a data storage unit 12, an input unit 13, a display unit 14, and a communication unit 15.

The control unit 11 performs data passing among the units and controls the entire server device 10. The control unit 11 includes a battle processing unit 111, an information changing unit 112, a conversion unit 113, and a screen creation unit 115. Specific operation of each unit will be described later.

The data storage unit 12 includes a read only memory (ROM) that is a read only storage area in which a system program is stored, and a random access memory (RAM) that is a rewritable storage area used as a work area for arithmetic processing by the control unit 11. The data storage unit 12 is, for example, realized by a non-volatile storage device, such as a flash memory or a hard disk. The data storage unit 12 of the present embodiment stores information about game media (e.g., game cards) and items which are used during the game. In addition, the data storage unit 12 stores player information which is information about game media and game items possessed by players during the game. The data structures of those pieces of information will be described later.

The input unit 13 is used by the system administrator and the like to input various types of data and the settings for the game (e.g., the settings for participation game media which will be described later, and the like). The input unit 13 is realized by, for example, a keyboard, a mouse, and the like.

The display unit 14 is used for displaying an operation screen for the system administrator based on a command from the control unit 11, and is, for example, realized by a liquid crystal display (LCD) and the like.

The communication unit 15 is used to perform communication with the player terminals 20, and has a function as a reception unit that receives various types of data and signals transmitted from the player terminals 20, and a function as a transmission unit that transmits various types of data and signals to the player terminals 20 in response to commands from the control unit 11. The communication unit 15 is, for example, realized by a network interface card (NIC), and the like.

### <Player Terminal 20>

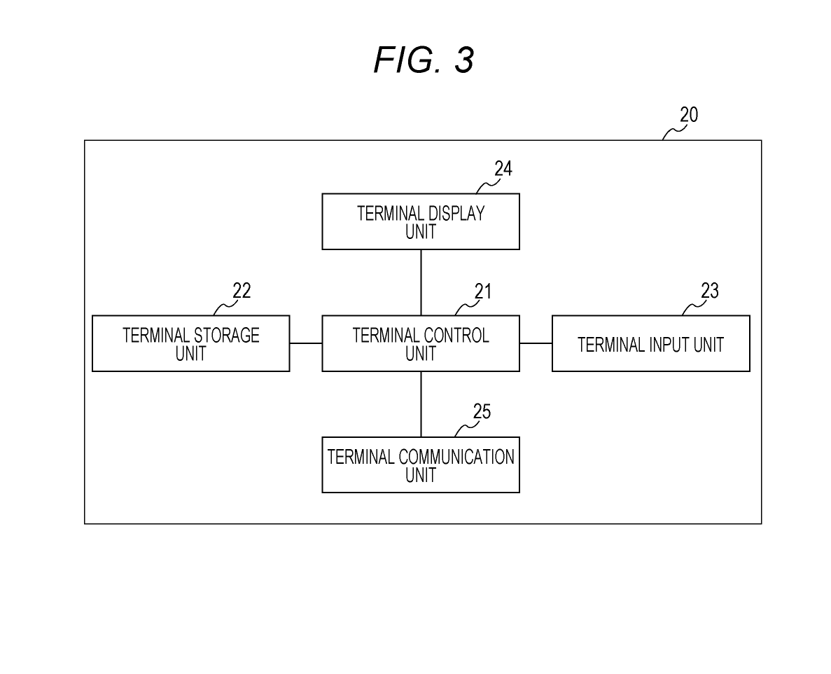

FIG. 3 is a block diagram illustrating a functional configuration of the player terminal 20. The player terminal 20 is an information processing terminal operated by the player (user) when playing the game. The player terminal 20 is, for example, a mobile phone terminal, a smartphone, a personal computer, a game machine, and the like, and transmits and receives information to/from the server device 10 accessible through the network 2. The player terminal 20 of the present embodiment includes a terminal control unit 21, a terminal storage unit 22, a terminal input unit 23, a terminal display unit 24, and a terminal communication unit 25.

The terminal control unit 21 performs data passing among units and controls the entire player terminal 20, and is realized by the central processing unit (CPU) executing a program stored in a predetermined memory. Note that the terminal control unit 21 of the present embodiment also functions as a screen display control unit that controls a display form of the game screen displayed in the terminal display unit 24.

The terminal storage unit 22 is connected to the terminal control unit 21 through a bus, and performs processing of referring to, reading out, and rewriting stored data according to a command from the terminal control unit 21. The terminal storage unit 22 is realized, for example, by a flash memory, a hard disk, and the like.

The terminal input unit 23 is used by the player to perform various types of operations (a game operation, a text input operation, and the like) and is realized by, for example, operation buttons, a touch panel, and the like.

The terminal display unit 24 is used to display a game screen (e.g., a battle screen which will be described later, and the like) which is created based on game information and in response to a command from the terminal control unit 21. The terminal display unit 24 is realized by, for example, a liquid crystal display (LCD) and the like.

The terminal communication unit 25 is used to perform communication with the server device 10, and has a function as a reception unit that receives various types of data and signals transmitted from the server device 10, and a function as a transmission unit that transmits various types of data and signals to the server device 10 in response to commands from the terminal control unit 21. The terminal communication unit 25 is, for example, realized by a network interface card (NIC), and the like.

### [Outline of Game]

An outline of a game provided by the game system 1 will be described.

The game system 1 of the present embodiment can provide a player (user) with a battle game played using game media. In the following, a battle type card game which is played using game cards as an example of the game media will be described. Note that the game cards are digital content game cards and thus are virtual cards used in the virtual space of the game.

### <Battle Type Card Game>

The game system 1 according to the present embodiment can provide a battle type card game in which characters selected by a player are allowed to fight against characters of an opponent player, by which winning or losing is determined.

In the battle type card game, first, the player selects characters to do battle. In the present embodiment, the player can possess a plurality of game cards (virtual cards used in the virtual space of the game), and the game cards are associated with game characters, respectively. Hence, when the player selects one or a plurality of game cards for use in the battle from among his/her plurality of game cards, a character(s) associated with the selected game card(s) is set as a character for doing battle (battle game content).

Here, for battle game media, an attack type battle game content which is used upon attacking an opponent at battle, and a defense type battle game content which is used upon defending against an attack from an opponent at battle are set.

For example, the player selects 11 game cards (11 characters) from among his/her game cards, as battle game media used at attack, to organize attack type battle game media. The attack type battle game media are hereinafter also called an “attack deck”. The attack deck is composed of 1 king character card corresponding to the main character and 10 friend character cards other than the king character. If the king character is defeated at battle, the player loses.

Likewise, the player selects 11 game cards (11 characters) from among his/her game cards, as battle game media used at defense, to organize defense type battle game media. The defense type battle game media are hereinafter also called a “defense deck”. As with the attack deck, the defense deck is also composed of 1 king character card corresponding to the main character and 10 friend character cards other than the king character.

Note that although friend characters can be freely organized in each deck, a king character is common between the decks. Note also that the number of friend character cards organized in each deck is not limited to 10. Each game card (a character associated with a game card) is set with a level, and the values of parameters (e.g., attack point and defense point) set for the game card increase with an increase in level. Therefore, if a deck is organized using game cards with high levels, then more powerful battle game media are structured, and thus, the player can allow the battle with another player to progress advantageously.

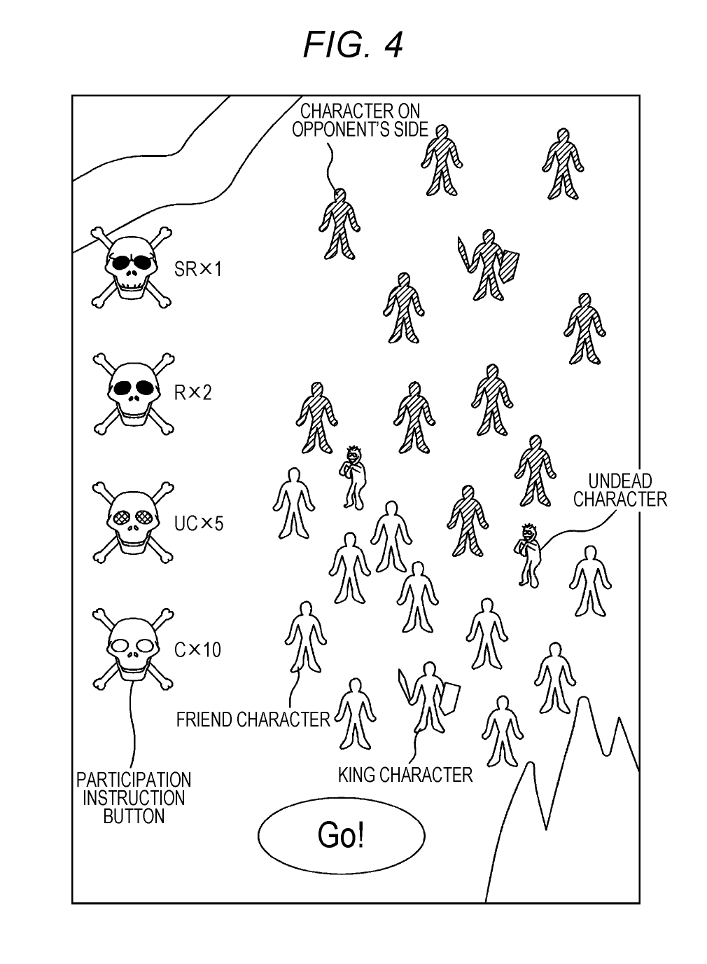

In addition, the player can set formations for attack and defense at battle. A formation is to determine how the king character and the friend characters are placed on a battle screen (see FIG. 4). In the present embodiment, if the king character is defeated at battle, the player loses. Thus, it is likely that the result of the battle greatly varies depending on how the king character is placed.

After organizing the attack deck and the defense deck and setting the formations, the player selects his/her opponent player to launch a battle, by which the battle starts. When the battle starts, the control unit 11 places the characters of the player and the opponent player on the battle screen, according to the set formations. FIG. 4 is a diagram illustrating an example of a battle screen of the game system 1. As illustrated in the drawing, a plurality of characters in the attack deck which is organized by the player as player side's characters are placed on the screen, and a plurality of characters in the defense deck which is organized by the opponent player as opponent side's characters are placed on the screen. In addition, participation game media (undead characters) which will be described later are also placed. Although in FIG. 4 the graphics of all characters are depicted in the same manner, in practice, the graphics vary according to the species and rarities of the characters (e.g., a dragon, a magician, and the like, also appear). Note that the functions of four skull mark icons (participation instruction buttons) displayed on the left edge of the screen in FIG. 4 will be described later.

At battle, a scene where those characters move around and fight against their opponents on the screen is displayed with animation to boost the battle. Then, winning or losing of the battle is determined according to the strengths of each other's decks. A criterion for determination is, for example, that the players damage each other's king characters and a player who first brings the hit point of a king character of his/her opponent to zero is the winner. Note that the method of determining winning or losing at battle is not limited thereto, and the determination may be made according to other criteria.

The player who has won the battle can acquire, as the reward for the win, in-game currency or an experience point usable in the game (hereinafter, also called an in-game point), or items and the like which are used in the game. In addition, the game cards used in the battle are added with the acquired experience point. When the experience point reaches a certain point or more, the levels of the game cards increase.

### <Participation Game Content>

In the game system 1, a participation game content which participates in a battle to aid the battle is provided in addition to 11 characters (11 game cards) included in player's battle game media (an attack deck or a defense deck). The participation game content is a game card associated with a character (hereinafter, also called an “undead character”) different than normal characters (king characters or friend characters). The undead character participates in a battle in response to a request from the player, and assists the combat by, for example, attacking an opponent in the same manner as other characters.

The undead character of the present embodiment is set with various types of parameters (at least any one of attack point, defense point, hit point, and level), as with normal characters.

Upon participating in a battle, the set parameters are consumed. For example, when the undead character is attacked by an opponent character, the hit point parameter is consumed, or when the undead character attacks an opponent character, the attack point parameter is consumed.

Note, however, that the characteristics of parameters differ between the normal characters and the undead character. For example, a normal battle game content (normal character) can recover its parameter consumed during the battle, by using a recovery item and the like. In addition, even if the hit point parameter reaches zero during the battle, by recovering the parameter, the normal battle game content can participate in the next and subsequent battles. Namely, regardless of the result of the battle, the player can continuously possess the battle game content. On the other hand, a participation game content (undead character) cannot recover its parameter consumed during the battle. When the hit point parameter reaches zero during the battle, the participation game content disappears and is no longer player's possession. That is, the participation game content functions like a disposable piece used to aid a battle with an opponent player.

In the present embodiment, a participation game content is created by converting a predetermined item, in response to a player's request upon doing battle. A method of creating a participation game content and specific operation performed upon doing battle using a participation game content will be described later.

### [Data Structure]

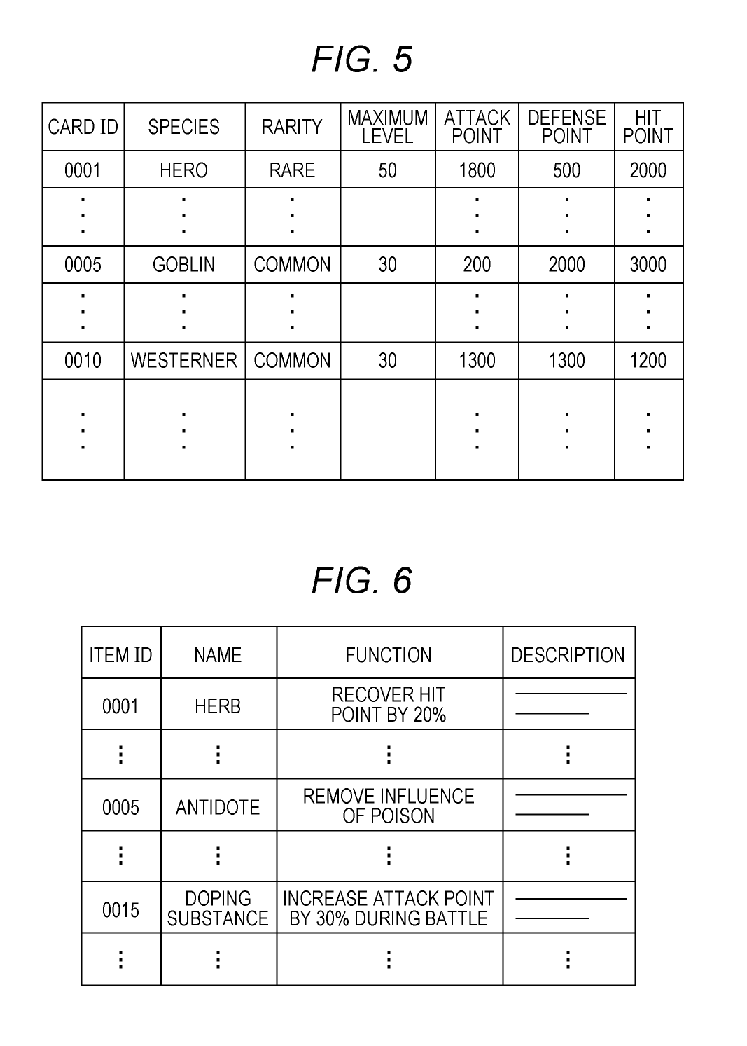

As described above, the data storage unit 12 of the server device 10 stores various types of information such as information about game cards and game items and player information. Various types of information used in the game system 1 of the present embodiment will be described using FIGS. 5 to 8.

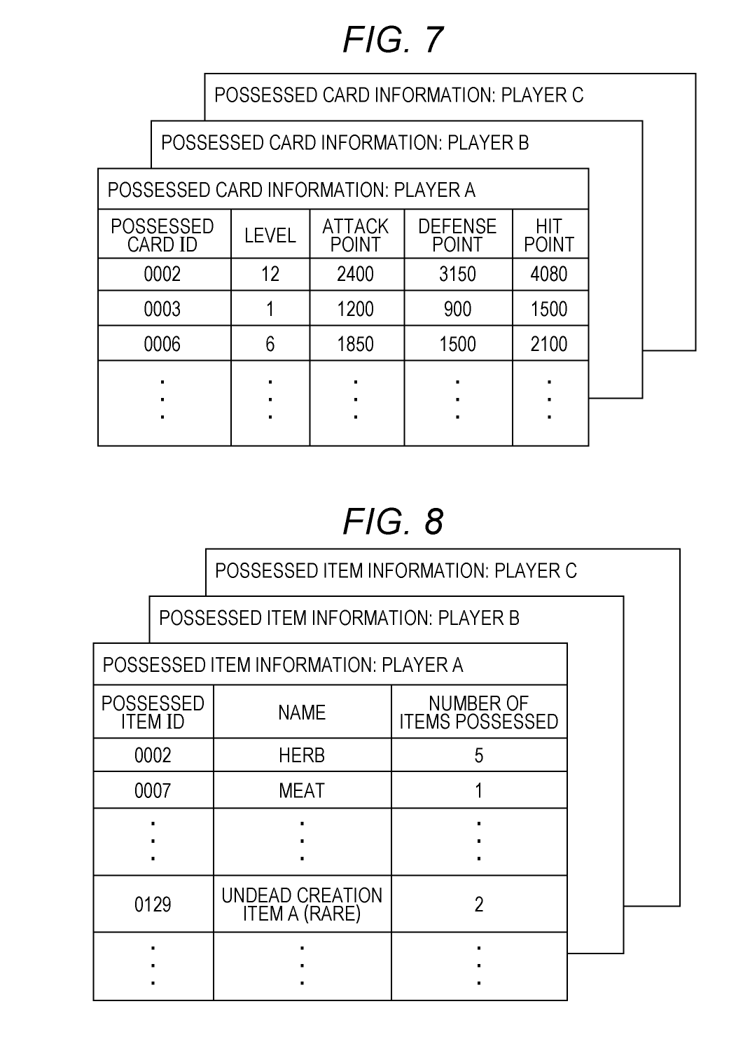

FIG. 5 is a diagram illustrating an example of a data structure of game card information. FIG. 6 is a diagram illustrating an example of a data structure of game item information. FIG. 7 is a diagram illustrating an example of a data structure of game cards possessed by players among the player information. FIG. 8 is a diagram illustrating an example of a data structure of items possessed by the players among the player information.

### <Game Card Information>

Game card information includes a card ID which is an example of identification information identifying a game card; and various types of information about the game card associated with the card ID. For example, as illustrated in FIG. 5, card information includes a card ID, the species of a character associated with a game card, rarity (rarity value), the maximum level of the character, and various types of parameters at an initial level, such as attack point, defense point, and hit point. In addition to them, the card information may include information such as a role for each character associated with the game card and a skill (special ability).

### <Item Information>

Item information includes an item ID which is an example of identification information identifying a game item; and various types of information about the game item associated with the item ID. For example, as illustrated in FIG. 6, item information includes an item ID, an item name, the function of the item, text information for describing the item to the player, and the like.

### <Player Information>

Of the player information, possessed card information is information indicating game cards possessed by each player. For example, as illustrated in FIG. 7, possessed card information includes a possessed card ID, the level of a character associated with the game card, and various types of parameters at that level, such as attack point, defense point, and hit point. Various types of parameters such as attack point can be calculated from the initial parameters of a game card stored as card information (see FIG. 5) and the level of the game card at the present time. Note, however, that the hit point parameter can also be treated as battle data upon doing battle, and thus, does not necessarily need to be included in the possessed card information. Note also that in addition to those pieces of information, the possessed card information may include information such as the date and time when the player has acquired the possessed card.

Of the player information, possessed item information is information indicating game items possessed by each player. For example, as illustrated in FIG. 8, possessed item information includes information such as the ID of a possessed item, the name of the item, and the number of items possessed. When the player acquires an item or uses (consumes) an item in the game, the number of corresponding items possessed changes.

In addition, as player information, in addition to the possessed card information and the possessed item information, information about the IDs, experience points, and possessed in-game currencies of the players, and the like, are also stored.

### [Description of Battle Using Participation Game Content]

Specific operation performed upon playing a battle game using a participation game content will be described.

Before playing a battle game using a participation game content in the game system 1, the player needs to gain in advance an item for creating a participation game content (hereinafter, also called an “undead creation item”). The undead creation item can be gained by the player selecting a predetermined game card from among his/her plurality of game cards and converting the selected game card. Then, upon doing battle, an undead character is created using the undead creation item and the undead character can be allowed to participate in the battle.

### <Gaining of Undead Creation Item>

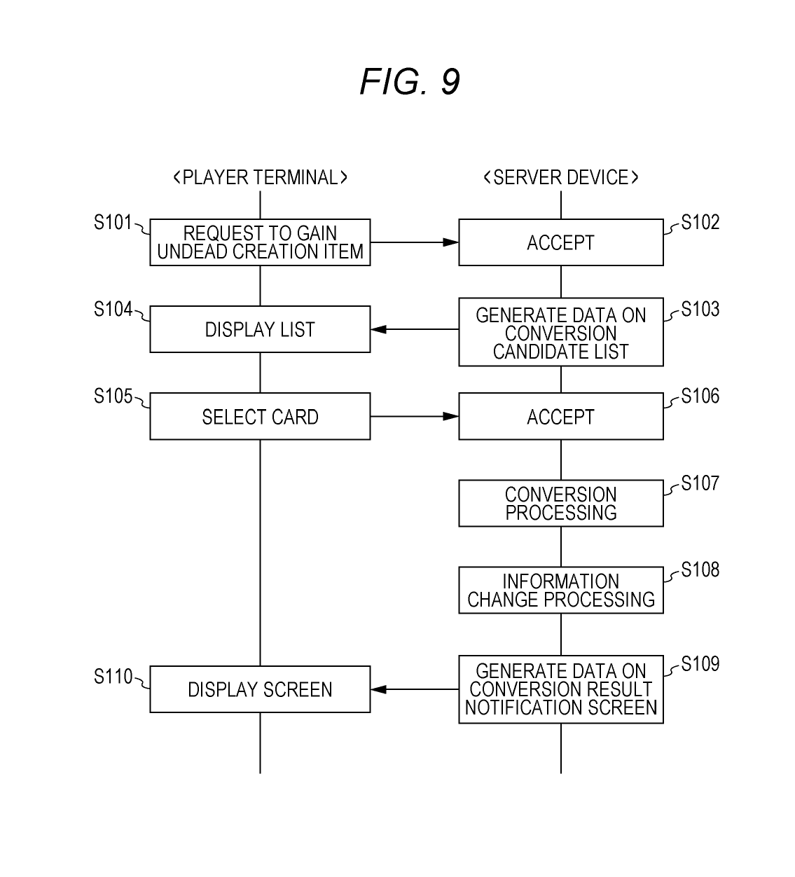

FIG. 9 is a diagram illustrating operation performed upon gaining an undead creation item.

First, the player makes a request to gain an undead creation item, using the player terminal 20 (S101). The request to gain is made by an input from a request button displayed on a game screen which is not shown. The request to gain is transmitted through the terminal communication unit 25, and is accepted by the server device 10 (S102).

When the request is accepted by the server device 10, the screen creation unit 115 in the control unit 11 generates data on a list screen (hereinafter, also called a conversion candidate list) of game cards serving as candidates for being converted into an undead creation item from among a plurality of game cards possessed by the player (S103). In the present embodiment, all game cards other than game cards associated with king characters which are the main characters can be converted into undead creation items. Therefore, the game cards of all friend characters possessed by the player are displayed on the conversion candidate list. The player can effectively use an unnecessary game card by converting the game card into an undead creation item.

Note that certain limitations may be imposed on game cards serving as candidates for being converted into an undead creation item. For example, it may be configured such that of a plurality of types of game cards, only game cards of a predetermined type can be converted into undead creation items, or only when the player possesses two or more of the same card, the cards can be converted into an undead creation item.

The data on the conversion candidate list is transmitted through the communication unit 15 to the player terminal 20 of the player having made the request to gain an undead creation item, and the conversion candidate list is displayed on the terminal display unit 24 (S104). The player selects a game card to be converted, as viewing the displayed conversion candidate list screen (S105). At this time, a plurality of game cards may be allowed to be selected at once. Allowing a plurality of game cards to be converted at a time can save the player time and trouble to repeatedly make a conversion request again and again.

When the server device 10 accepts the game card selection from the player (S106), the conversion unit 113 in the control unit 11 performs conversion processing (S107). The conversion processing is processing of converting the game card into an undead creation item.

The conversion unit 113 refers to the information on the game card selected as a conversion target from the player's possessed card information stored in the data storage unit 12, and defines the game card as a conversion source game card (game content). In the present embodiment, a conversion source game card is associated with undead creation items (conversion destination game items) which are different than the game card, and a correspondence therebetween is listed in advance. Based on the list, the conversion unit 113 associates the conversion source game card with any of the undead creation items into which the game card can be converted. That is, there are a plurality of types of undead creation items that can be converted based on a certain game card. Note that a method in which the conversion unit 113 randomly determines a conversion destination game item without using such a list, and the like, may be used. At this time, the strength of the conversion destination game item may change according to the level of the conversion source game card. Note also that the conversion source game card and the conversion destination game item may have a one-to-one correspondence.

Subsequently, the information changing unit 112 in the control unit 11 performs information change processing (S108). The information change processing is processing of changing the player information stored in the data storage unit 12, based on the result of the conversion processing. Specifically, of the player's possessed card information, data on the game card used for the conversion (conversion source game card) is removed. Then, data on the converted undead creation item (conversion destination game item) is added to the player's possessed item information (or an addition is performed on the number of corresponding items possessed). Here, information on an undead creation item (conversion destination game item) includes the rarity (rarity value) of the undead creation item, initial parameters such as attack point and hit point, a skill (a special ability exercised during a battle), and the like. The rarity is of, for example, four types, super rare (SR), rare (R), uncommon (UC), and common (C). A more powerful undead character can be created with higher rarity. Note that the rarity of the undead creation item is determined according to the rarity of the conversion source game card. For example, a game card whose rarity is common (C) is likely to be converted into an undead creation item whose rarity is common (C), and a game card whose rarity is rare (R) is likely to be converted into an undead creation item whose rarity is rare (R). Note, however, that there may be a case in which a conversion source game card and a conversion destination game item have different rarities. For example, there is a possibility that a game card whose rarity is common (C) may be converted into an undead creation item whose rarity is rare (R). The initial parameters of the undead creation item are the same as those of the conversion source game card. Note, however, that the initial parameters may change according to the level or rarity of the undead creation item.

After the conversion processing and the information change processing have been completed, the screen creation unit 115 generates data on a screen notifying the player of information about the undead creation item which is the resultant of the conversion processing (S109), and transmits the data to the player terminal 20.

The player can confirm that the undead creation item has been created from the selected game card, by viewing the notification screen displayed on the terminal display unit 24 (S110).

### <Creation of Undead Character>

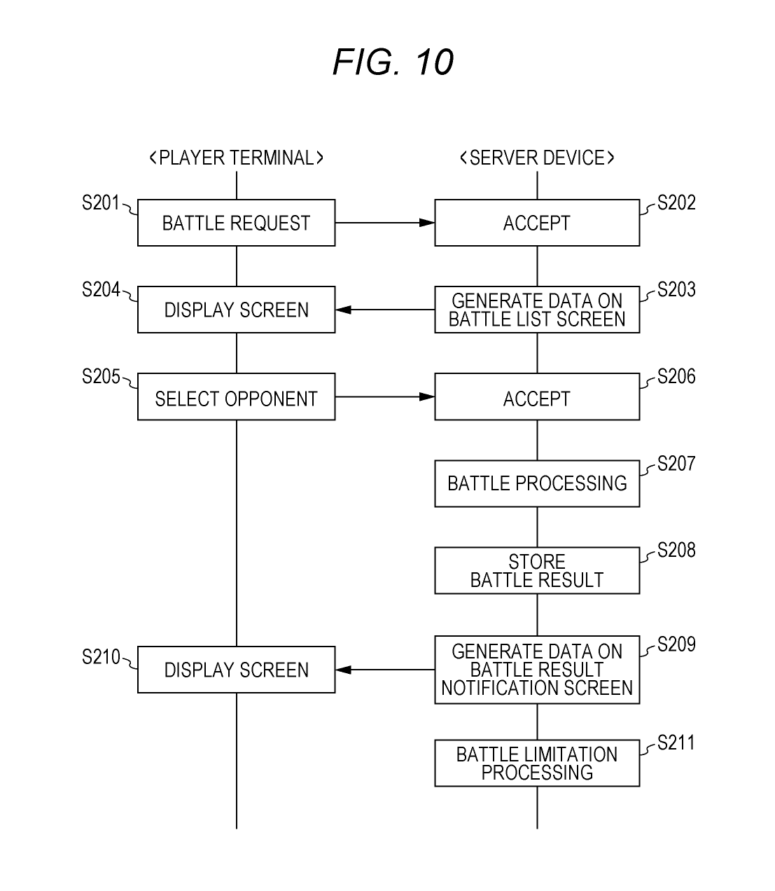

Next, the operation of creating an undead character from an undead creation item and allowing the undead character to participate in a battle will be described. FIG. 10 is a diagram illustrating the flow of battle operation of the game system 1. Note that it is assumed that organization of an attack deck and a defense deck which are used when doing battle has already been completed.

First, a player (player A) who wants to do battle with another player makes a battle request from the player terminal 20 (S201). The battle request is made on a game screen (not shown) displayed on the terminal display unit 24 of the player terminal 20, and is transmitted to the server device 10 through the terminal communication unit 25.

When the server device 10 accepts the battle request from the player A (S202), data on a battle list screen for allowing the player A to select an opponent is generated (S203). The control unit 11 extracts a plurality of other players from among the users of the game system 1, as candidates for a player A's opponent. Then, the screen creation unit 115 generates data on a battle list screen including information such as the extracted battle candidate players and the defense decks of the respective battle candidate players. Note that instead of displaying all of those pieces of information on the battle list screen, a part of the information may be hidden. For example, some characters (game cards) organized in a defense deck of a battle candidate player may be hidden. Since a part of the information on opponents is not displayed, when the player A selects his/her opponent, the player A needs to determine the strength of his/her opponent while estimating information which is the hidden portion. By this, a player A's zest for the game at battle can be increased.

Upon creating a battle list screen, arbitrary players are extracted as opponent candidates. Note, however, that it may be configured such that players who organize defense decks of a comparable strength are extracted as much as possible. When a battle takes place between players with a comparable strength, the battle is likely to become a close battle, allowing the players to anticipate a more thrilling development.

The generated data on the battle list screen is transmitted by the communication unit 15 to the player terminal 20 of the player A, and the battle list screen is displayed on the terminal display unit 24 (S204). Note that when, as described above, a part of the information on the battle list screen is hidden, all data (information) does not necessarily need to be transmitted to the player terminal 20, and a part of the data may be transmitted.

The player A selects a player with whom he/she wants to do battle, as viewing the displayed battle list screen (S205).

When the player A selects a player serving as an opponent and the server device 10 accepts the player A's selection (S206), a battle starts. In the following, description is made assuming that player B is selected as the opponent of the player A.

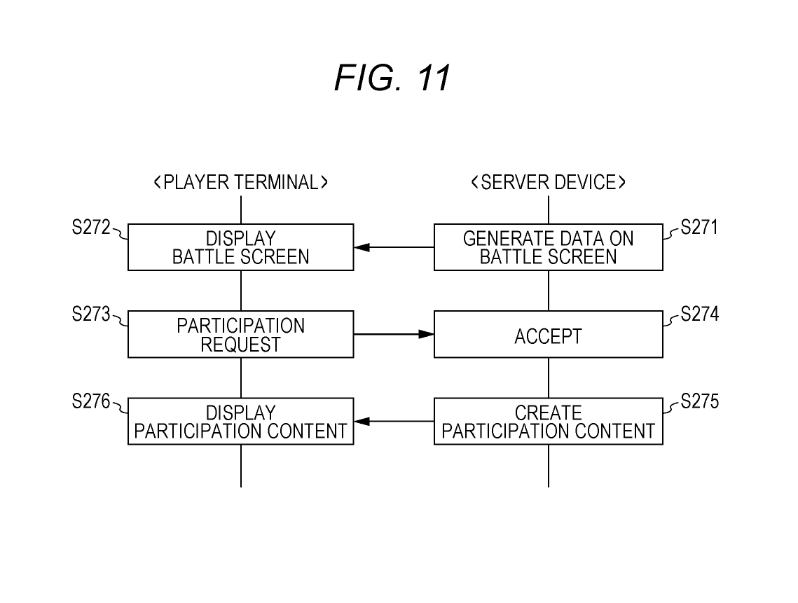

When the battle starts, the battle processing unit 111 in the control unit 11 performs battle processing (S207). FIG. 11 is a diagram illustrating operation in the battle processing which is performed when an undead character is allowed to participate in the battle. When the battle processing starts, first, the screen creation unit 115 in the control unit 11 generates data on a battle screen (see FIG. 4) (S271). The battle screen data is transmitted to the player terminal 20 of the player A, and the battle screen is displayed on the terminal display unit 24 (S272). On the battle screen, a combat scene between characters on the player A side and characters on the player B side is displayed with animation.

While the battle is done, the player A can request to allow a participation game content (undead character) to participate in the battle. The player A makes a participation request by pressing a predetermined participation instruction button displayed on the battle screen (S273). In FIG. 4, four skull marks displayed on the left edge of the screen are participation instruction buttons. The four buttons correspond to rarities, super rare (SR), rare (R), uncommon (UC), and common (C), respectively. When the player A presses the instruction button for rare (R), an undead character with rare (R) is created by consuming an undead creation item whose rarity is rare (R) from among undead creation items possessed by the player A. Therefore, when the player A does not possess an undead creation item corresponding to a rarity of an instruction button, the player A cannot make a participation request for an undead character with that rarity. In addition, the number displayed next to each button in FIG. 4 represents the number of use limitations during the battle. For example, in the case of FIG. 4, the rare (R) button can be used twice during the battle. Namely, up to two undead characters with rare (R) can be allowed to participate in the battle. Imposing use limitations can suppress the occurrence of the problem that a large amount of undead characters participate in one battle, resulting in loss of force balance between the players.

When the server device 10 accepts the participation request for a participation game content from the player A (S274), the battle processing unit 111 creates an undead character (participation game content) by consuming an undead creation item (S275). Note that the number of undead creation items consumed is subtracted from the player A's possessed item information.

The strength (parameters) of an undead character to be created is determined according to the parameters of an undead creation item to be consumed (i.e., initial parameters set for a conversion source game card) and the rarity of the undead creation item. Basically, lower parameters are set for an undead character that is created from an undead creation item with lower rarity. For example, the parameters of an undead character whose rarity is rare (R) have values on the order of 70 to 100% of initial parameters set for a conversion source game card, and the parameters of an undead character whose rarity is common (C) have values on the order of 20 to 50% of initial parameters set for a conversion source game card. In this case, it is highly likely that an undead character to be created is set with lower parameters than parameters set for a conversion source game card. Therefore, the problem that due to an undead character being too powerful, an extreme difference occurs in force between the players can be suppressed.

In addition, the parameters of an undead character may be determined based on parameters set for a specific game card. For example, when the strength of a king character serves as a reference strength, an undead character whose rarity is rare (R) has a strength equivalent to that of the king character in the battle, and an undead character whose rarity is common (C) has a strength (parameters) which is 30% of the strength (parameters) of the king character in the battle. Since the strength of the king character serves as a reference strength, the importance of the king character further increases among player characters.

In addition, the undead character may have a skill according to its rarity. The skill is a special ability exercised during a battle. For example, an undead character whose rarity is rare (R) has a skill to bite an opponent character to give big damage to the opponent character, and an undead character whose rarity is common (C) has a skill to give poison to an opponent character. In addition to them, various skills are set.

Data on the created undead character is transmitted to the player terminal 20 of the player A, and the undead character appears on the battle screen displayed on the terminal display unit 24 (S276). Then, the undead character participates in the battle together with other characters. Note that the position (placement) where the undead character appears on the battle screen may be determined according to a formation set by the player A or may be randomly determined.

Referring back to FIG. 10, winning or losing of the battle is determined by which one of the players has defeated an opponent king character first, and the battle result is stored based on the determination (S208). In the storing of the battle result, the information changing unit 112 in the control unit 11 changes possession information of game cards, items, in-game points (in-game currency and the like) possessed by the players, and stores the changed information in the data storage unit 12. For example, a predetermined amount of in-game point which is a transfer target is subtracted from the player information of a player having lost the battle, and the subtracted amount of in-game point or a part thereof is added to the player information of a player having won the battle, and those pieces of player information are stored.

In addition, information about an undead character of each player (e.g., the remaining value of the hit point parameter and the like) may also be stored in the data storage unit 12, and in the next and subsequent battles the undead character may be allowed to participate in the battles with the last information (the hit point parameter and the like) taken over.

After the information change processing, the screen creation unit 115 generates data on a battle result notification screen notifying the player A of the result of the battle (S209). The screen data is transmitted to the player terminal 20 of the player A through the communication unit 15, and the screen is displayed on the terminal display unit 24 (S210).

In addition, battle limitation processing of limiting the next and subsequent battles to take place is performed (S211). If a battle is repeated without limitation, then the load on the server device 10 may increase, resulting in that services related to the game system 1 may not be able to be smoothly provided. In addition, if a battle like fighting over each other's items is allowed, then trouble and the like may occur between the players. Hence, when battle is consecutively done in the game system 1, certain limitations are imposed. For example, an item to be consumed upon launching a battle against another player is provided, and battle can be done for the number of such items possessed, or once battle has been done, the player cannot launch a battle against another player for 10 minutes thereafter. Such conditions are set as limitation information, and battle limitation processing is performed based on the limitation information after battle is done, by which battle is suppressed from being done without limitation.

In such a battle type card game provided by the game system 1, the player creates a participation game content (undead character) using an unnecessary card, and utilizes the participation game content, by which the player can allow the battle with another player to progress advantageously. Accordingly, game media can be effectively used without making the player feel monotonous.

### Other Embodiments

The above-described embodiment have been given for easy understanding of the present invention, and are not used to construe the present invention in a limited manner. Needless to say, the present invention may be changed or modified without departing from the gist thereof, and the present invention includes equivalency thereof. In addition, embodiments described below are also included in the present invention.

### <Participation Game Content>

Although in the above-described embodiment an example is described in which a parameter (hit point) of a participation game content does not recover during a battle, the parameter of the participation game content may recover under a predetermined condition. For example, a participation game content (undead character) whose rarity is super rare (SR) is allowed to recover its hit point parameter. Alternatively, a participation game content may have a skill to recover its hit point parameter.

In addition, the participation game content itself may be provided with the concept of a level, and the level may go up according to operation performed during a battle (e.g., the magnitude of damage done to an opponent character, and the like), and its parameters may increase.

In addition, it may be configured such that the performance of the participation game content changes according to the circumstances at battle. For example, when the participation game content participates in a battle during daytime hours in the in-game time, its various types of parameters decrease by 20%. On the other hand, when the participation game content participates in a battle during nighttime hours in the in-game time, its various types of parameters increase by 20%.

### <Undead Creation Item>

Although in the above-described embodiment, upon creating a participation game content (undead character), an increase or decrease of the quantity (number) of undead creation items is managed, a data management method for undead creation items is not limited thereto. For example, undead creation items are managed by flags, and when the player selects a predetermined card from among his/her game cards to convert the card into an undead creation item during the progress of the game, the flag is set to ON. A method in which management is performed such that the flag being set to ON is one of the conditions for creating an undead character, and the like, are also considered.

### <Information Processing Device>

In the above-described embodiment, the game system 1 including one server device 10 as an example of an information processing device has been exemplarily described. However, the game system 1 is not limited to the example, and may include a plurality of server devices 10 as information processing devices. That is, a plurality of server devices 10 is connected through a network 2, and each of the server devices 10 may perform various types of processing in a distributed manner.

Further, it may be configured such that the player terminal 20 bares a part of the functions as the information processing device. In this case, the server device 10 and the player terminal 20 constitute the information processing device.

### <Game Program>

In the game system 1 of the above-described embodiment, an example in which the server device 10 and the player terminal 20 are allowed to cooperated with each other has been described. The present invention also includes a game program for performing processing performed by the server device 10 and the player terminal 20. Specifically, the server device 10 serving as an information processing device and the player terminal 20 may perform the above-described processing, based on the game program.

What is claimed is:

1. A server device connected to an information processing terminal through a network and controlling a game in which a player battles with another player by operating game media in game space, the server device comprising:
a storage unit that stores player information including information on the plurality of game media possessed by the player and a game item possessed by the player;
a conversion unit that converts a predetermined game content from among the plurality of game media possessed by the player into a game item different than the game content; and
an information changing unit that changes the player information such that the converted game content is managed as a game item.

2. The server device according to claim 1, further comprising a battle processing unit that exercises, when there is a request from the player to consume the game item upon doing the battle, predetermined functions of the game item in response to the request.

3. The server device according to claim 2, wherein
the predetermined functions of the game item include:
creating a participation game content that participates in the battle;
consuming a parameter set for the participation game content when the participation game content participates in the battle; and
not allowing the consumed parameter to recover during the battle.

4. The server device according to claim 3, wherein
the storage unit stores information about a number of the game items, as the player information, and
the information changing unit changes the player information such that every time the conversion is performed, the converted game content from among the game media possessed by the player is removed, and an addition is performed on the number of the game items possessed by the player.

5. The server device according to claim 3, wherein
the game content being a conversion source is set with a higher parameter than a parameter set for the participation game content created using the game item being a conversion destination.

6. The server device according to claim 3, wherein
when the battle processing unit creates the participation game content from the game item, the battle processing unit sets a parameter of the participation game content, based on a parameter set for a specific game content among the plurality of game media possessed by the player.

7. The server device according to claim 3, wherein
the parameter includes information on at least any one of attack point, defense point, hit point, and level of the game content or the participation game content.

8. The server device according to claim 3, wherein
the participation game content has predetermined rarity, and
a parameter set for the participation game content varies according to the rarity.

9. The server device according to claim 3, wherein
the participation game content has predetermined rarity, and
the participation game content is set with a skill according to the rarity.
